(19) United States
(12) Patent Application Publication
(10) Pub. No.: US 2026/0235104 A1
(43) Pub. Date: Aug. 13, 2026

(54) Wind turbine rotor, wind turbine rotor module, wind panel with the wind turbine rotor module, method for manufacturing the wind turbine rotor

(71) Applicant: VP SYSTEM SP Z O.O., Opole (PL)

(72) Inventors: Rafal Juszko, Wroclaw (PL); Tomasz Gruszka, Wroclaw (PL); Arkadiusz Zemlak, Siechnice (PL); Jakub Zajdel, Warszawa (PL)

(21) Appl. No.: 19/155,090

(22) PCT Filed: Feb. 13, 2024
(86) PCT No.: PCT/IB2024/051319

§ 371 Date: Aug. 8, 2025

(30) Foreign Application Priority Data
Feb. 17, 2023 (PL) P.443825

(51) Int. Cl. F03D 3/06; F03D 9/00; F03D 9/25; F03D 80/00

(52) U.S. Cl. CPC F03D 3/061; F03D 9/007; F03D 9/25; F03D 80/005; F05B 2220/706; F05B 2240/211

(57) ABSTRACT

A wind turbine rotor (1) for a wind turbine has a vertical axis of rotation. The rotor includes a tube portion (16) with a plurality of rotor blades (2) equally angularly spaced from one another. The rotor is essentially in the shape of a longitudinally pleated tube. The blades (2) each comprise a pleat on an outer surface formed by a shorter wall (3) and a longer wall (4). The tubular portion with the shorter walls and longer walls of the blades on the outer surface bound an inner space (14) of the wind turbine rotor. A wind turbine rotor module including the wind turbine rotor and a wind panel including at least three wind turbine rotor modules may be used to generate electricity even at low wind speeds.

### TECHNICAL FIELD

Exemplary arrangements include a wind turbine rotor for a wind turbine with a vertical axis of rotation, a wind turbine rotor module, a wind panel with the wind turbine rotor module and a method for manufacturing the wind turbine rotor to be used in converting the kinetic energy of the wind, particularly low-speed wind, into electrical energy. In addition, some exemplary arrangements can be used as a fence for a property, road or urban space, or may be installed on the roofs of buildings and in other locations where it is possible to convert wind energy into electrical energy.

### BACKGROUND

Obtaining electrical energy from renewable energy sources is currently a very important element of the energy management. So-called “clean energy sources” such as the sun, wind, water (rivers, tides and sea waves) or geothermal energy are particularly important because their resources are renewed in a relatively short period of time and their use is not harmful to the environment. However, environmental conditions in different parts of the world are not always favorable enough to freely use renewable energy sources. In the case of wind, a common obstacle is low speeds, which are difficult to use effectively for electrical energy production. This is because converting low wind speeds into electrical energy is associated with the need to increase the active area of the wind turbine. Increasing the surface of a wind turbine, on the other hand, increases the cost of its manufacture.

Wind turbines are known that convert low-speed wind kinetic energy into electrical energy. However, such wind turbines have a relatively small working surface, and their manufacture is a long and complicated process. In addition, the efficiency of these types of devices is low, which often makes their use uneconomical.

US patent document U.S. Pat. No. 8,912,679B2 the disclosure of which is incorporated herein by reference in its entirety, discloses a modular wind turbine system with electrically conductive structural rails supporting wind turbines. The wind turbines drive electric generators, which are connected to two parallel rails at their upper and lower ends. Individual modules are electrically and mechanically linked to adjacent modules. Electrical energy generated by the generators is conveyed to a location where it is consumed or passed for onward transmission. Wind turbines are an elongated strip with a vertical axis of rotation. The wind turbine system is mounted on a frame at a certain level above the surface of the ground.

Spanish patent document ES1249377U relates to a wind panel that uses wind power to produce electrical energy. The disclosed panel comprises a number of cone-shaped wind rotors that are wind-driven. The rotors are aligned side by side in a straight or zig-zag line. Each rotor is connected to the alternator and is seated on a support plate perpendicular to the axis of the rotors. The system is a cuboid-shaped structure with two spaces. The upper one is for the rotors and is equipped with holes to receive the wind, while the lower one is for the alternators.

US patent document U.S. Pat. No. 8,536,720B2 the disclosure of which is incorporated herein by reference in its entirety, describes wind energy apparatus, made up of a plurality of modular wind energy devices or units. Each unit has a housing and at least two turbines mounted on the housing. Each of the turbines has a blade set having a vertical axis and extending upward from the housing. Generators are disposed in the housing and connected to the turbines accordingly. The units, when placed together, connect their poles (positive and negative), together completing a circuit.

US patent document US20180171981A1 the disclosure of which is incorporated herein by reference it its entirety, discloses an integrated modular wind turbine, which can operate at high and low wind speeds. Individual modules of the wind turbines are arranged horizontally-oriented or vertically-oriented. A module comprises two circular, non-rotatable stators, two circular rotors, with at least one magnet affixed to each rotor, and a plurality of turbine blades. The turbine blades are curved planes, which are attached to the rotors with their ends. The rotors which contain magnets rotate around the central axis of the module in proximity to the conducting coils, creating a rotating magnetic field. Thus, each module of the wind turbine generates electrical energy.

Current devices and systems may benefit from improvements.

### SUMMARY

Exemplary arrangements described herein solve technical problems by providing a wind turbine rotor, a wind turbine module and a wind panel, which will make it possible to effectively convert low-speed (1-4 m/s) wind energy into electrical energy. Moreover, the exemplary wind turbine rotor, the wind turbine module and the wind panel have a durable structure and are weather-resistant. In some exemplary arrangements the material of which the wind turbine rotor is made is widely available and its acquisition does not involve high financial outlays. In addition, in some exemplary arrangements the wind panel comprises an environmentally friendly device that operates to convert energy from renewable energy sources into electrical energy as effectively as possible. In some exemplary arrangements the operation of the wind turbine rotor, the wind turbine module and the wind panel is safe and does not adversely affect the functioning of nearby humans so that these elements can be mounted in urban spaces. In some exemplary arrangements the method for manufacturing the wind turbine rotor does not require high financial outlays, is fast and uncomplicated.

An exemplary arrangement includes a wind turbine rotor for a wind turbine with a vertical axis of rotation, the rotor comprising a plurality of rotor blades equally spaced from one another. The rotor is essentially in the shape of a longitudinally pleated tube, whose pleats are blades. “Pleating” when used herein means a pattern with regular folds formed by impressions in the shape of blades of the rotor. In some exemplary arrangements each blade is formed on an outer annular surface of an elongated tube portion by a shorter wall and a longer wall, with the tube portion including said shorter walls and longer walls of the blades defining an inner space of the wind turbine rotor, and the cross-section of the rotor forms a closed figure. Thus, the exemplary rotor moves as a result of the wind acting on the outer surfaces of the blade walls when the rotor is in use.

In some exemplary arrangements the rotor has a lid that closes its upper end. The lid may tightly close the upper end of the rotor or the fastening of the lid may provide a slot or other opening for free heat dissipation. The exemplary lid protects the inside of the rotor, e.g. against the rain entering inside the rotor.

In some exemplary arrangements the shorter blade walls and longer blade walls are convex.

In some exemplary arrangements the number of blades of the wind turbine rotor is uneven.

In some exemplary arrangements the number of blades of the wind turbine rotor is 3, 5 or 7.

In some exemplary arrangements the rotor is made of plastic, a mixture of plastic and secondary plastic, or aluminium, which materials can be easily shaped by extruding an endless web of material.

In some exemplary arrangements the outer surface of the rotor is coated with a semiconductor photovoltaic material, such as monocrystalline silicon, polycrystalline silicon or perovskite material.

In some exemplary arrangements at least part of the inner space of the rotor is filled with an acoustically insulating material, such as polyurethane, polyethylene or a mixture thereof.

Some exemplary arrangements include a wind turbine rotor module which comprises a wind turbine rotor. In some arrangements a generator, seated on a fixed turbine shaft, a lower inner bearing, for ensuring rotation of the rotor around the fixed turbine shaft, and an upper inner bearing, arranged on the fixed turbine shaft in the area from half the height of the fixed turbine shaft to its upper end, are placed in the inner space of the wind turbine rotor.

Some exemplary arrangements include a wind panel which comprises at least three wind turbine rotor modules, wherein the modules are seated on a lower support rail.

In some exemplary arrangements the wind turbine rotor modules are connected to the lower support rail via a fixed turbine shaft.

In some exemplary arrangements the wind panel also comprises an upper support rail, with the upper inner bearing being attached to the upper support rail.

Some exemplary arrangements include a method for manufacturing a wind turbine rotor, the method comprising the steps of:
a) raw material is delivered to the extruder,
b) the raw material is heated to obtain the plastic state of the material,
c) the plastic material is pushed through a shaping head which shapes the material into a profile being a longitudinally pleated tube, whose pleats are blades, and each blade is formed by a shorter wall and a longer wall, with said shorter walls and longer walls of the blades defining a hollow inner space of the profile, and the cross-section of the profile forms a closed figure,
d) the obtained profiles are cut to a pre-set length.

Thus, as a result in some exemplary arrangements, a web of material is extruded in the pre-set shape of a hollow, pleated tube with the “pleats” being impressions on the outer annular surface of the side wall in the shape of rotor blades. The web of material thus produced is cut to the pre-set length. In the hollow inner space of the rotor thus produced, components such as acoustic insulation material, the generator and bearings can be located.

In some exemplary arrangements the raw material used in the method is plastic, a mixture of plastic and secondary plastic or aluminium.

In some exemplary arrangements the amount of secondary plastic used in carrying out the method is at least 30 wt % of the total amount of the material.

In some exemplary arrangements the plastic is polyvinyl chloride (PVC), polypropylene (PP) and/or polyethylene (PE).

In some exemplary arrangements the wind turbine rotor, the wind turbine rotor module and the wind panel make it possible to effectively convert low-speed wind energy into electrical energy. In some exemplary arrangements no free spaces between the rotor blades means that the wind strikes directly the windward surface of the blade so that more wind energy is used than in standard wind turbine rotors. Such a rotor structure provides an increased active surface of the device compared to the solutions known in the prior art. In the wind panel of some exemplary arrangements, the air stream flows between the rotors (and not between the free spaces between the blades), thus increasing its speed and at the same time ensuring more efficient operation of the device. In addition, in some exemplary arrangements the side wall of the rotor may be coated with a material that converts solar or thermal energy into electrical energy, making the effectiveness of the device even higher. In some exemplary arrangements because of the small diameter of the rotor, the rotor blades reach relatively low angular velocities, and as a result, the rotor operation is quiet and free from flickering. This means that the operation of the wind turbine rotor does not cause the effect that the blades cast flickering shadows, which, at high frequencies, can be very disturbing to humans. Furthermore, in some exemplary arrangements with the inner space of the rotor filled with an acoustically insulating material, the turbines can additionally act as acoustic screens to absorb ambient noise. The operation of the wind turbine rotor, the wind turbine rotor module and the wind panel is therefore more silent and does not affect human functioning, and so it possible to mount the devices in urban space. Moreover, in some exemplary arrangements in an urban space, the wind panel can be used as a fence.

In some exemplary arrangements placing the components of the rotary mechanism inside the rotor increases the durability of the rotor module and improves the resistance to external conditions.

In some arrangements mounting the wind turbine rotor on a single, stationary turbine shaft ensures that the rotor is held firmly and permanently in its intended location. With a flexible printed circuit board (PCB flex) used to construct the generator stator of the rotor module, the generator is more resistant and can reach higher rotational speeds.

In some exemplary arrangements placing the generator inside the wind turbine rotor makes it possible for the individual rotor modules in the wind panel to work independently. In addition, the wind turbine rotor module may have a low weight, which makes it possible to support it by means of slide bearings, which further extends the life of the device. Moreover, in some arrangements because of the low weight of the device, any accidental touching of the wind turbine rotor blades while in operation causes the rotor to stop easily and is not dangerous. In some exemplary arrangements the individual modules of the wind panel are arranged on one support rail, with the stability of the structure being maintained, which reduces the workload and costs of manufacturing the wind panel. Additionally, in arrangements with only one support rail used, the wind panel modules can absorb the impact of an animal, for example, by deflecting and then returning to the working position without damage to the structure and without harm to the animal. In addition, attaching the wind panel to the ground or a building foundation ensures that it is stably positioned.

In some arrangements the manufacture of the wind turbine rotor is carried out in an extrusion process, using commonly available plastics, which ensures that the method for manufacturing the rotor does not require high financial outlays, is fast and easy, and the rotor thus manufactured is characterised by high durability to mechanical damage and weather conditions. In addition, in some exemplary arrangements the rotor material can also be a mixture of plastic and secondary plastic or other waste materials, which further reduces manufacturing costs.

### BRIEF DESCRIPTION OF DRAWINGS

FIG. 1A shows an exemplary wind turbine rotor in a front top perspective view.

FIG. 1B shows an axial cross-section of the exemplary wind turbine rotor of FIG. 1A.

FIG. 2 shows a structure diagram of an exemplary wind turbine rotor module.

FIG. 3 shows an exploded view of an exemplary wind panel.

FIG. 4 shows the wind panel according to another exemplary arrangement.

FIG. 5 shows an axial cross-section of a wind turbine rotor according to another exemplary arrangement.

FIG. 6A shows a wind turbine rotor according to another exemplary arrangement in a front top perspective view.

FIG. 6B shows the rotor of FIG. 6A with the lid closing its upper end.

### DETAILED DESCRIPTION

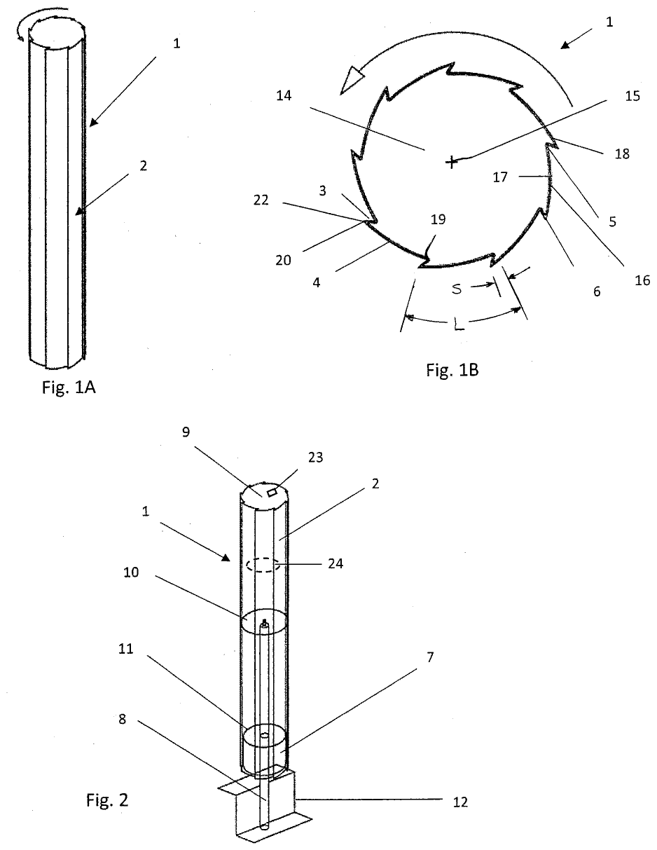

Referring now to the drawings and particularly to FIG. 1 the blades 2 of the rotor 1 have a longitudinal shape and define the side wall of the rotor. Thus, it can be said that the side wall defined by the wind turbine rotor blades is a uniform, longitudinal structure whose cross-section is essentially annular and defines the closed inner space of the wind turbine rotor. The wind turbine rotor 1 is essentially in the shape of a longitudinally pleated tube with the “pleats” being impressions on the annular outer surface of the side wall in the shape of the rotor blades. In the exemplary arrangement shown each blade is formed in axial cross section by a shorter wall 3 and a longer wall 4. The outer surfaces of the longer walls 4 of the individual blades are the leeward surfaces of the rotor, and the outer surfaces of the shorter walls 3 of the individual blades are the windward surfaces of the rotor. It can therefore be said that the windward surface of the blade extends from the trailing edge 5 of the previous blade to the leading edge 6 of the current blade, and the leeward surface of the blade extends from the leading edge 6 of the current blade to the trailing edge 5 of the current blade.

The wind turbine rotor 1 is illustrated in a schematic view in FIGS. 1A, and 1B. In this exemplary arrangement, the wind turbine rotor 1 comprises nine rotor blades 2 which define the side wall of the wind turbine rotor 1, with the rotor blades 2 having a longitudinal shape and being equally spaced from one another. The wind turbine rotor 1 is essentially in the shape of a longitudinally pleated tube with the “pleats” being impressions on the outer surface of the side wall in the shape of the rotor blades. Each blade is formed by a shorter wall 3 and a longer wall 4. The direction of movement of the rotor under wind force is indicated by a counter clockwise arrow. The blades 2 of the turbine have windward surfaces which are the outer surfaces of the shorter walls 3 and leeward surfaces which are the outer surfaces of the longer walls 4. The windward surface extends from the trailing edge 5 of the previous blade 2 to the leading edge 6 of the current blade 2. The leeward surface extends from the leading edge 6 of the current blade 2 to the trailing edge 5 of the current blade 2. In this exemplary arrangement the windward surface of the blade 2 is a flat surface and the leeward surface of the blade 2 is a convex surface. However, it should be understood that in alternative rotor arrangements, these surfaces can be flat, convex or concave, provided that the basic functionality of the wind turbine rotor 1 is maintained, i.e. the effective use of low-speed wind energy.

The shorter walls 3 and the longer walls 4 of the blades 2 define the inner space 14 of the wind turbine rotor 1, and the cross-section of the rotor 1 forms a closed figure. The upper end of the wind turbine rotor 1 is closed with a lid 9. The lid provides protection for the inner space 14 against e.g. precipitation and may tightly close the upper end of the rotor or the fastening of the lid may provide a slot 23 or other type openings for free heat dissipation.

As shown in FIG. 1B the exemplary rotor 1 is rotatable about an axis of rotation 15. The rotor is comprised of an axially elongated tube portion 16 that includes an annular inner surface 17 and an annular outer surface 18. The annular inner surface 17 bounds the inner space 14.

The exemplary annular outer surface 18 includes a plurality of angularly spaced blades 2 each of which comprises an axially elongated pleat. Each blade 2 on the annular outer surface, includes a shorter wall 3 and a contiguous longer wall 4. Each longer wall 4 of the blade extends between a first longer wall end 19 and a second longer wall end 20. As shown in FIG. 1B the second longer wall end extends further radially outward from the axis of rotation than the second longer wall end. Each shorter wall 3 extends between a first shorter wall end 21 and a second shorter wall end 22 that corresponds to the second longer wall end 20.

As shown in FIG. 1B each longer wall extends through a longer outer wall angle (L) on the annular outer surface 18 that is greater than a shorter outer wall angle(S) through which the shorter wall extends on the annular outer surface. In the exemplary arrangement as shown, at least a portion of the shorter wall angle on the annular outer surface through which the shorter wall of a blade extends, angularly overlaps with the longer outer wall angle that is occupied by the longer wall of the immediately adjacent blade. As shown in the drawings, in this exemplary arrangement the leading edge 6 includes at least a portion of the shorter wall 3 of the respective blade that is angled outward on the annular outer surface in a direction that is opposite to the direction of the rotor 1.

In an exemplary arrangement, the wind turbine rotor 1 has a diameter of 11.5 cm and a side wall thickness of 3 mm. The diameter of the wind turbine rotor 1 is the diameter of the circle circumscribed around the annular axial cross-section of the wind turbine rotor 1. The height of the exemplary wind turbine rotor 1 is 200 cm. The exemplary wind turbine rotor 1 has nine blades 2 and the leading edge 6 of each of the blades 2 is at a distance of 7 cm from the vertical central axis of the wind turbine rotor 1. The distance between the leading edge 6 and the vertical central axis of the wind turbine rotor 1 is exemplary, and in alternative arrangements, it can be longer or shorter. According to an exemplary arrangement the leading edge 6 of the blade 2 will be located within a distance in the range 0.55-0.82 of the diameter length of the wind turbine rotor 1 from the vertical central axis of the turbine rotor 1. The number of blades 2 of the rotor 1 is exemplary, and in alternative arrangements, it can be higher or lower. According to some exemplary arrangements, the number of blades 2 of the wind turbine rotor 1 will be defined by a ratio of 0.4-1.1 blade 2 per each 10 mm of the diameter of the wind turbine rotor 1. The height of the wind turbine rotor 1 is exemplary and in alternative arrangements it can be a lower or higher value. According to some exemplary arrangements the height of the rotor will be in the range of 10-40 times the diameter length of the wind turbine rotor 1.

The wind turbine rotor 1 in an exemplary arrangement rotates at a speed of 50 revolutions per minute at a wind speed of 1 m/s. However, it should be understood that the parameters with regard to the diameter, thickness of the side wall, and rotational speed of the wind turbine rotor 1 referred to herein are exemplary and in alternative arrangements, they can be lower or higher values, provided that the effective conversion of low-speed wind energy into electrical energy is maintained.

The method for manufacturing an exemplary wind turbine rotor 1 is carried out in the following steps. First, raw material is supplied to an extruder and heated to obtain the plastic state of the material. Then, the plastic material is pushed (extruded) through a suitable mold or die. The profile thus obtained is cut to form shorter elements being the wind turbine rotors 1. In this exemplary approach the side wall of the wind turbine rotor 1 thus made has no connection point between separate pieces, as it is a single uniform element. In some exemplary arrangements the raw material used to manufacture the rotor is polyvinyl chloride (PVC).

A further exemplary arrangement including the wind turbine rotor 1 module is shown in FIG. 2. The wind turbine rotor 1 module comprises the wind turbine rotor 1 and rotary mechanism components that are located in the inner space 14 of the wind turbine rotor 1. Generally, the structure of the wind turbine rotor 1 and the method for manufacturing the exemplary rotor are substantially similar to the structure of and method for manufacturing the wind turbine rotor 1 previously described. Therefore, the similar structure elements and steps of the method will not be repeated for the sake of clarity of the disclosure. In this exemplary arrangement, the thickness of the side wall of the rotor 1 is 2 mm and the outer surface of the side wall is additionally coated with a material that converts solar energy into electrical energy, the material in this exemplary arrangement being monocrystalline silicon. It should be understood that the type of material that the side wall of the rotor 1 is coated with is exemplary and in alternative arrangements, other material that converts solar (light) energy into electrical energy, e.g. polycrystalline silicon or perovskite may be used. Additionally, in the exemplary arrangement the inner space 14 of the wind turbine rotor 1 is filled with an acoustically insulating material 24 in the form of a polyurethane foam. However, it should be understood that the type of the acoustically insulating material is exemplary and in alternative arrangements other material, (for example, polyethylene), which has the functionality of limiting the noise emitted by the wind turbine rotor 1 module may be used.

Components of the exemplary rotary mechanism are located in the inner space of the wind turbine rotor 1 and include a generator 7, a fixed turbine shaft 8, a lower inner bearing 11 and an upper inner bearing 10. The exemplary electrical generator 7 is seated on the fixed turbine shaft 8, which is arranged in the vertical axis of the wind turbine rotor 1. On the top surface of the generator 7, a lower inner bearing 11 is arranged to ensure rotation of the wind turbine rotor 1 around the fixed turbine shaft 8. The upper inner bearing 10 is arranged at the end of the fixed turbine shaft 8 at half the hight of the wind turbine rotor 1.

The exemplary generator 7 comprises a rotor and a stator. The exemplary generator 7 rotor is a resin cast element, while the stator is a flex printed circuit board (PCB). The material of which the generator 7 rotor is made is exemplary and in alternative arrangements the material may be an adhesive, a polymer or a mixture of ferrite powder (iron oxide) and a binder such as a resin, adhesives or other polymers, allowing low-energy processing of the rotor material. In this exemplary arrangement, the wind turbine rotor 1 is made of a mixture of plastic (polypropylene) and secondary plastic in the amount of 30 wt % of the mixture. It should be understood that the amount of plastic is exemplary and in alternative arrangements other amounts may be used, provided that the structure of the wind turbine rotor 1 is durable and resistant to weather conditions.

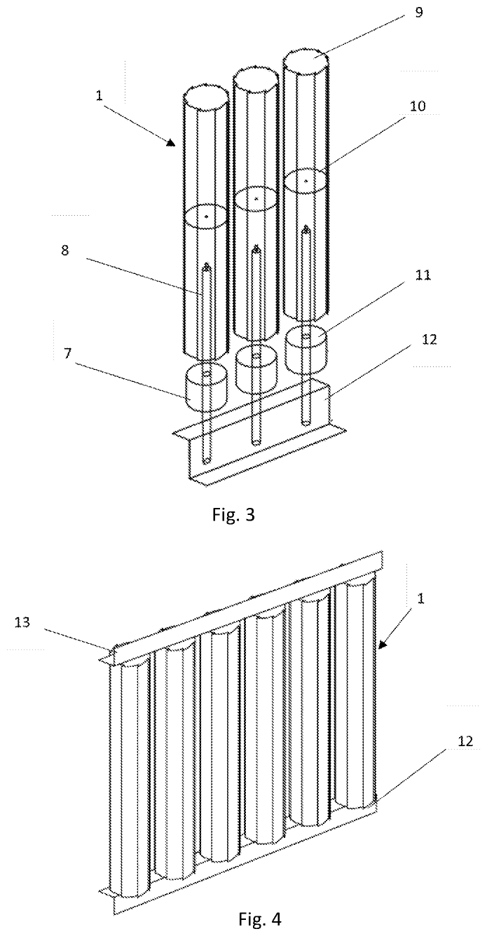

An exemplary wind panel is shown in FIG. 3. The wind panel according to this exemplary arrangement comprises three wind turbine rotor 1 modules, which are seated on a lower support rail 12 in a line one next to the other at intervals of 2 cm. It should be emphasised that the distances between the individual rotor 1 modules arranged on the support rail 12 are exemplary and in alternative arrangements the distances can be shorter or longer, provided that the effective conversion of low-speed wind energy into electrical energy is maintained. Generally, the structure of the wind turbine rotor 1 module is substantially similar to the structure of the wind turbine rotor 1 module previously described.

In this exemplary arrangement, the wind turbine rotor 1 modules are attached to the lower support rail 12 via corresponding fixed turbine shafts 8. Additionally, an electrical installation to pass the electricity produced by the modules, with cable trays connecting successive generators 7 of the modules, is placed in the lower support rail 12.

A further exemplary wind panel arrangement is shown in FIG. 4. Generally, the structure of this wind panel is broadly similar to the structure of the wind panel presented in FIG. 3, which is why similar structural elements will not be repeated for the sake of clarity of the disclosure.

In this exemplary arrangement, the wind panel comprises six wind turbine rotor 1 modules that are arranged on the lower support rail 12 one next to the other at a distance of 3 cm from each other, wherein the wind panel further has an upper support rail 13. The wind turbine rotor 1 modules are attached to the upper support rail 13 via the upper inner bearing 10, which, in this exemplary arrangement may be similar to the lower support rail and is located at the upper end of each of the wind turbine rotor 1 modules. The fixed turbine shaft 8 extends to a height of 10 cm. Of course it should be understood that these features while useful, are exemplary and in other arrangements other features and configurations may be used.

FIG. 5 shows an exemplary wind turbine rotor 1 in an axial cross-section. In this exemplary arrangement, the rotor has seven blades and both the leeward surface being the outer surface of the longer wall 4 of the blade 2 and the windward surface being the outer surface of the shorter wall 3 of the blade 2 comprise convex surfaces.

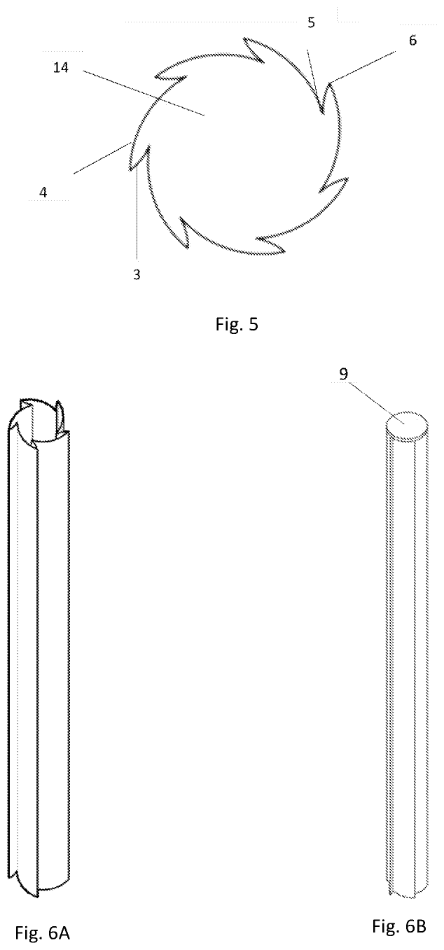

FIG. 6A shows an exemplary wind turbine rotor 1 in a front top perspective view. In this exemplary arrangement, the rotor has five blades, in which both the shorter walls 3 and the longer walls 4 are convex. FIG. 6 shows clearly that the wind turbine rotor 1 is in the shape of a longitudinally pleated tube, where the pleats are the rotor blades 2. As previously discussed, “Pleating” as used herein is defined as a pattern with regular folds formed by impressions in the shape of blades of the rotor. According to some exemplary arrangements, the rotor 1 of FIGS. 6A and 6B is 14-15 cm in diameter and 100-300 cm long.

FIG. 6B also shows the exemplary rotor having a lid 9 closing the upper end of the rotor of FIG. 6A.

Thus the exemplary arrangements achieve improved operation, eliminate difficulties encountered in the use of prior devices and systems, and attain the useful results described herein.

In the foregoing description, certain terms have been used for brevity, clarity and understanding. However, no unnecessary limitations are to be implied therefrom because such terms are used for descriptive purposes and are intended to be broadly construed. Moreover the descriptions and illustrations herein are by way of examples and the new and useful concepts are not limited to the exact features shown and described.

It should be understood that the features and/or relationships associated with one exemplary arrangement can be combined with features and/or relationships from another exemplary arrangement. That is, various features and/or relationships from various arrangements can be combined in further arrangements. The inventive scope of the disclosure is not limited to only the exemplary arrangements shown or described herein.

Having described the features, discoveries and principles of the exemplary arrangements, the manner in which they are constructed and operated, and the advantages and useful results attained, the new and useful features, devices, elements, arrangements, parts, combinations, systems, equipment, operations, methods, processes and relationships are set forth in the appended claims.

### LIST OF REFERENCE NUMERALS

1—wind turbine rotor,
2—rotor blade,
3—shorter wall,
4—longer wall,
5—trailing edge,
6—leading edge,
7—generator,
8—turbine shaft,
9—lid,
10—upper inner bearing,
11—lower inner bearing,
12—lower support rail,
13—upper support rail,
14—inner space
15 axis of rotation
16 tube portion
17 annular inner surface
18 annular outer surface
19 first longer wall end
20 second longer wall end
21 first shorter wall end
22 second shorter wall end
23 opening
24 acoustically insulating material

1. -16. (canceled)

17. Apparatus comprising:
a wind turbine rotor, wherein the wind turbine rotor
is adapted to rotate about an axis of rotation,
includes an axially elongated tube portion, wherein the tube portion includes
an annular inner surface, wherein the inner surface bounds an inner space,
an annular outer surface, wherein the outer surface includes
a plurality of angularly spaced blades, wherein each blade comprises an axially elongated pleat,
wherein in axially transverse cross-section each blade on the outer surface includes
a longer wall and a shorter wall, wherein the longer wall
extends through a longer outer wall angle on the outer surface that is larger than a shorter outer wall angle on the outer surface through which the shorter wall extends on the outer surface,
extends on the outer wall surface between a first longer wall end and a second longer wall end, wherein the second longer wall end is disposed further radially outward from the axis of rotation than the first longer wall end,
wherein the shorter wall
extends on the outer wall surface between a first shorter wall end and a second shorter wall end,
wherein the second shorter wall end corresponds to the second longer wall end of the longer wall of the respective blade, and the first shorter wall end corresponds to a first longer wall end of in immediately angularly adjacent blade that extends on the outer wall surface.

18. The apparatus according to claim 1
wherein in an operative position the axis of rotation extends vertically.

19. The apparatus according to claim 1
wherein at least a portion of the shorter outer wall angle angularly overlaps the longer outer wall angle of the immediately adjacent blade.

20. The apparatus according to claim 1
wherein the axially elongated tube in an operative position includes an axially upper end,
wherein the rotor further includes
a lid, wherein the lid closes the inner space at the upper end.

21. The apparatus according to claim 1
wherein the axially elongated tube in an operative position includes an axially upper end,
wherein the rotor further includes
a lid, wherein the lid bounds the inner space at the upper end and includes at least one cooling opening therethrough.

22. The apparatus according to claim 1
wherein the longer wall and the shorter wall of each respective blade are convex.

23. The apparatus according to claim 1
wherein the rotor comprises an odd number of blades.

24. The apparatus according to claim 1
wherein at least a portion of the annular outer surface is coated with a semiconductor photovoltaic material.

25. The apparatus according to claim 1
wherein the inner space houses an acoustically insulating material.

26. The apparatus according to claim 1
and further comprising:
a generator, wherein the generator
extends in the inner space, and
is in operative connection with the axially elongated tube portion,
wherein rotation of the rotor causes the generator to produce electrical power.

27. The apparatus according to claim 1
and further comprising:
a support rail,
a turbine shaft, wherein the turbine shaft
extends along the axis of rotation, and
is in fixed operative connection with the support rail,
a generator, wherein the generator
extends in the inner space,
is in operative connection with the axially elongated tube portion and the turbine shaft,
wherein rotation of the rotor causes the rotor rotation relative to the turbine shaft and the generator to produce electrical power.

28. The apparatus according to claim 1
and further comprising:
a support rail,
a plurality of rotors, wherein each rotor
is mounted in operative connection with the support rail and in spaced relation from each of the other rotors,
wherein each rotor is enabled to rotate in operatively supported connection with the support rail.

29. The apparatus according to claim 1
and further comprising:
a first support rail and a second support rail, wherein the first support rail is spaced away from the second support rail,
a plurality of rotors, wherein each rotor
is in operatively supported connection with each of the first support rail and the second support rail,
extends intermediate of the first support rail and the second support rail,
is spaced away from each of the other rotors,
wherein each rotor is rotationally movable in operatively supported connection with the first support rail and the second support rail.

30. The apparatus according to claim 1
and further comprising:
a first support rail and a second support rail, wherein the first support rail is spaced away from the second support rail,
a plurality of rotors, wherein each rotor
includes a respective electric generator within its respective inner space,
is in operatively supported connection with each of the first support rail and the second support rail,
extends intermediate of the first support rail and the second support rail, is spaced away from each of the other rotors,
wherein each rotor is rotationally movable in operatively supported connection with the first support rail and the second support rail, and each generator is operative responsive to rotation of its respective rotor to deliver electricity through one or more of the first support rail and the second support rail.

31. The apparatus according to claim 1
and further comprising:
a first support rail and a second support rail, wherein the first support rail is spaced away from the second support rail,
a plurality of rotors, wherein each rotor
includes a respective electric generator within its respective inner space,
includes a semiconductor photovoltaic material coating on the respective annular outer surface of the rotor,
is in operatively supported connection with each of the first support rail and the second support rail,
extends intermediate of the first support rail and the second support rail,
is spaced away from each of the other rotors,
wherein each rotor is rotationally movable in operatively supported connection with the first support rail and the second support rail, and each rotor is operative responsive to rotation of the respective rotor and its respective generator, and the impingement of light on its respective photovoltaic coating, to deliver electricity through one or more of the first support rail and the second support rail.

32. The apparatus according to claim 1
wherein the axially elongated tube portion consists of a single extruded piece.

33. The apparatus according to claim 1
wherein the axially elongated tube portion is comprised of a single extruded piece that is comprised of one or more of plastic and aluminum.

34. The apparatus according to claim 1
wherein the inner space includes
an electric generator, and
acoustically insulating material.
